(19) United States
(12) Patent Application Publication
(10) Pub. No.: US 2004/0232671 A1
(43) Pub. Date: Nov. 25, 2004

(54) Apparatus for controlling airbag inflation

(76) Inventor: Martin Specht, Feldafing (DE)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/840,300

(22) Filed: May 7, 2004

(30) Foreign Application Priority Data
May 20, 2003 (DE) 103 22 708.3

(51) Int. Cl. B60R 21/20

(52) U.S. Cl. 280/735; 701/45

(57) ABSTRACT

The inflation of an airbag is controlled by an apparatus using inflation gas for the protection of a vehicle occupant in a crash. The movement of the vehicle occupant as well as the movement of the airbag toward a vehicle occupant is detected by a sensor device. The supply of inflation gas from an inflator to the airbag is controlled in dependence on corresponding sensor signals.

### FIELD OF THE INVENTION

The present invention relates to an apparatus in which the position of a vehicle occupant is detected for the controlling inflation of an airbag for the protection of a vehicle occupant in a crash.

### BACKGROUND OF THE INVENTION

EP 1 071 583 A1 teaches an apparatus and a method which employs a radar module to detect if the vehicle seat is occupied by a vehicle occupant. In addition a proximity sensor is provided that detects whether the vehicle occupant is positioned so closely to the airbag that during the inflation of the airbag there is a risk of injury.

From EP 0 812 741 B1 it is known to perform sensing of the advance movement of an airbag during the inflation of the airbag, whereby upon the impact of the airbag with an object, for instance a vehicle occupant, the amount of gas supplied to the airbag is adjusted depending on the detected distance traveled by the airbag in the sense of a reduced inflation volume.

Apparatuses for adjusting the inflation gas supplied to the airbag are known from DE 100 45 035 A1 and EP 0 974 500 A1.

In the present invention the movement, in particular the speed of movement and acceleration of the vehicle occupant as well as the movement of the airbag toward a vehicle occupant in particular with regard to speed and/or acceleration are detected and corresponding electrical sensor signals are generated. The amount of inflation gas that is to be supplied to the airbag is controlled in dependence on these sensor signals. To this effect the apparatus has a sensor device, which measures the movement of the vehicle occupant and the movement of the airbag toward the vehicle occupant, and a control device controls the inflation gas supply to the airbag in dependence on the detected measurement values. Associated movement detectors for the detection of occupant movement and the detection of the airbag advance movement can be employed in the sensor device.

The detection of the position and/or the movement of the vehicle occupant as well as the detection of the airbag advance movement are preferably carried out at different times, whereby the position and/or movement measurement of the vehicle occupant is carried out in time prior to the triggering of the airbag inflation process. The detection of the vehicle occupant movement can however also take place during the airbag inflation process.

The detection of the position and/or movement of the vehicle occupant as well as the movement of the airbag toward a vehicle occupant can be measured by radar. In this case preferably a measurement is carried out using Doppler radar, as is known for example from DE 44 20 432 C2, DE 195 35 962 C1 or EP 0 638 818 B1.

The same measurement system, in particular Doppler radar measurement system, can be advantageously used for the detection of the position and/or movement of the vehicle occupant as well as for the detection of the airbag advance movement.

The detection of the position and/or movement of the vehicle occupant can already be carried out in a critical driving situation where the likelihood of a crash is high (pre-crash situation), in particular with the help of the Doppler radar. The activation of the Doppler radar system takes place in dependence on the sensor signals, which for instance can detect an emergency braking or skidding, or a similar pre-crash behavior of the vehicle.

The detection of each position and/or movement of the vehicle occupant, however, preferably takes place in time after the exceeding of a threshold value (crash beginning) of a vehicle deceleration or a vehicle acceleration. The detection of the behavior of the vehicle occupant, in particular of the influence of the crash event on the vehicle occupant, is carried out prior to the initiation of the inflation process of the airbag. In this manner the position and/or movement detection of the vehicle occupant occurs in a time window between the crash beginning and the beginning of the inflation process of the airbag during a time frame of approximately 10 m/s for instance. Depending on the beginning of the airbag inflation process, this time window can be of shorter or longer duration. The detection of the occupant movement can, however, be continued during the inflation of the airbag.

The influence of the crash event on the vehicle occupant depends on numerous factors, as for instance the position of the vehicle seat within the vehicle, the size and weight of the vehicle occupant, the severity of the crash, the position of the vehicle occupant on the vehicle seat, the extension length of the seat belt to be worn, and the like. Due to the present invention, the actual behavior of the vehicle occupant or the influence of the crash event on the vehicle occupant during the course of the crash is detected without the requirement for monitoring these influence values individually, and the inflation gas supply to the airbag is controlled in dependence thereof. If the vehicle occupant moves in the direction of the airbag module, for instance at a high speed of movement, the supply of inflation gas to the airbag can be adjusted in such a manner that a safe catching of the vehicle occupant is achieved by the amount of inflation gas supplied. In addition, in dependence on the occupant movement, further restraining devices can be activated in a controlled manner. For instance a load limiting device, with which the restraining force is exerted upon the vehicle occupant from the seat belt, can be adjusted.

In the event that the monitoring of the vehicle occupant position and/or movement already occurs in the pre-crash phase, a controlled pretensioning of the seat belt, for instance by an electric motor drive, can take place in a reversible manner in dependence on the detected measurement signals.

In the event that the vehicle seat, in particular the passenger seat, is occupied by a light-weight person, for instance a child, the airbag, on the basis of the detected movement pattern, can be controlled in such a manner that it unfolds with a reduced effect, to avoid injury to the vehicle occupant due to the accelerated airbag advance movement.

### BRIEF DESCRIPTION OF THE DRAWINGS

FIG. 1 shows a first embodiment during detection of the vehicle occupant movement prior to airbag inflation.

FIG. 2 shows the embodiment of FIG. 1 during airbag inflation.

FIG. 3 shows a second embodiment during airbag inflation; and

FIG. 4 shows an airbag module with a built-in sensor device.

### DETAILED DESCRIPTION OF THE INVENTION

The embodiments shown in the drawings are used for the controlled inflation of an airbag 1. The airbag can be a passenger airbag, which is arranged in the instrument panel of a vehicle 12 in front of the passenger seat, or to a driver airbag, which is arranged in the steering wheel.

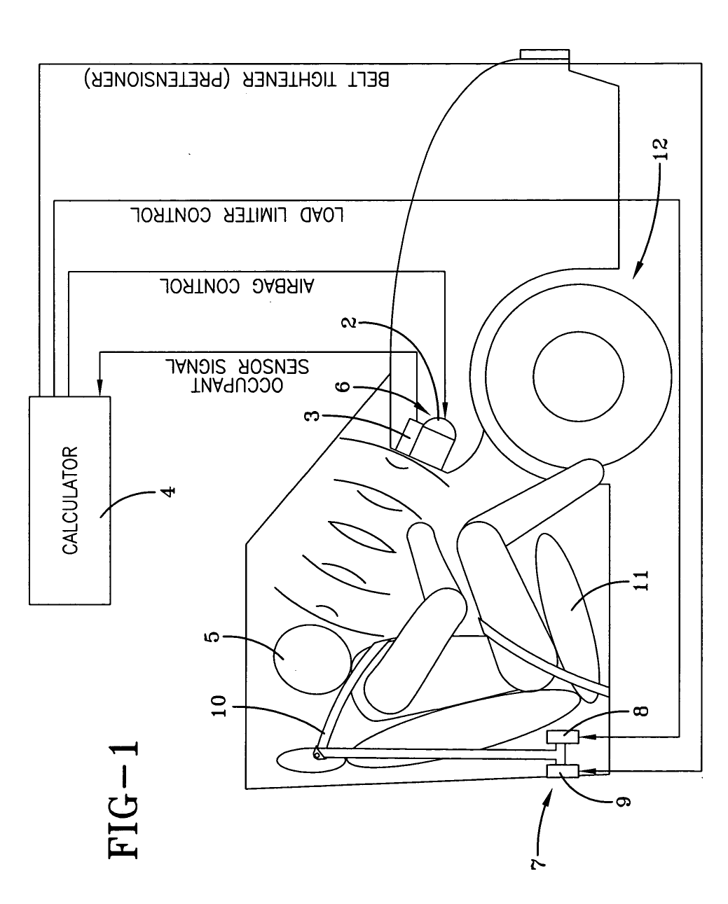

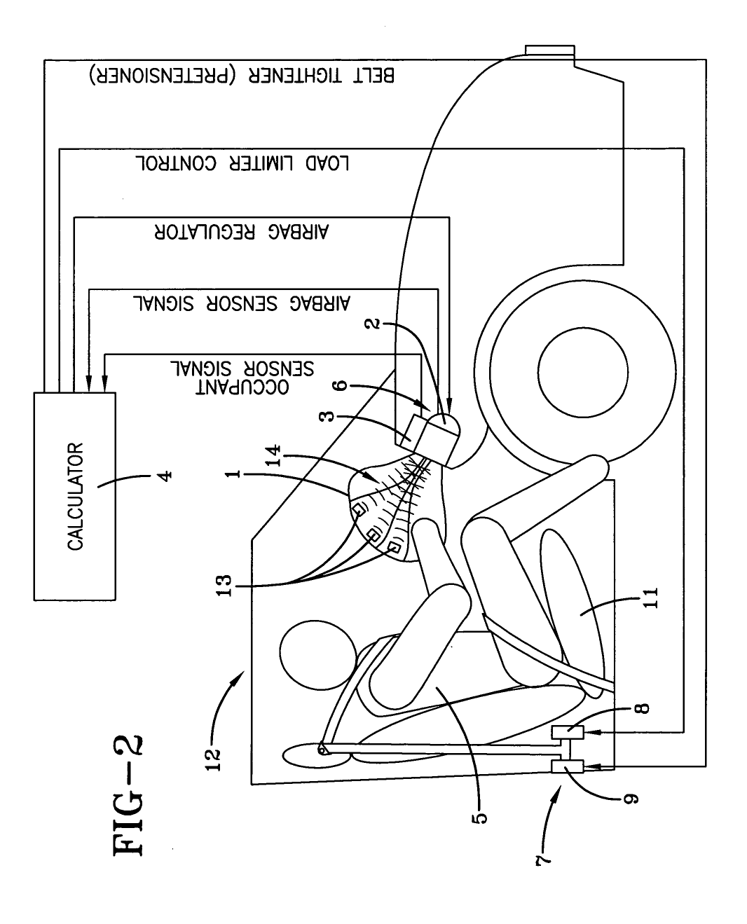

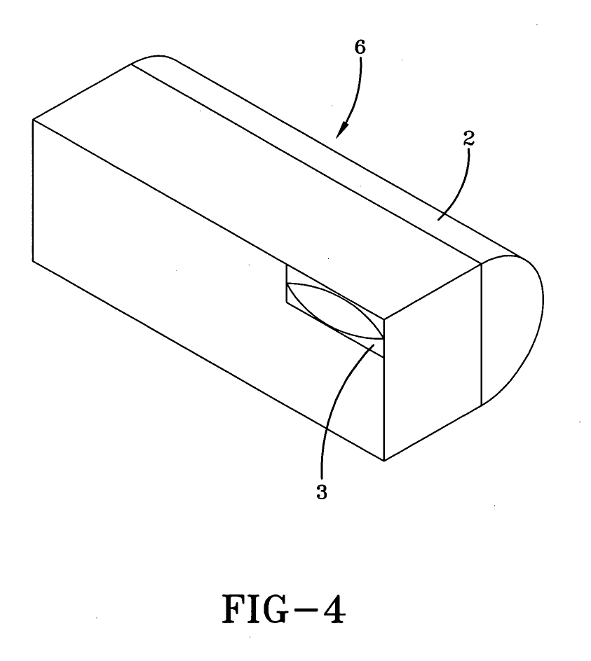

The airbag 1 is inflated by an inflator 2, which either generates a pyrotechnically created gas, or releases stored gas, or is a hybrid inflator or the like. During the inflation of the airbag, the airbag moves towards a vehicle occupant 5 occupying a vehicle seat 11. The inflator 2 and the airbag 1 are located in an airbag module 6. A sensor device 3 is located in the proximity of the airbag module 6 or as an additional component in the airbag module 6 (FIGS. 1, 2 and 4). The sensor device 3 measures the movement of the vehicle occupant, in particular the speed of movement and/or the acceleration of the vehicle occupant and the movement of the airbag toward the vehicle occupant. The speed of movement of the airbag toward a vehicle occupant and/or the advance movement acceleration of the airbag and generates corresponding electrical sensor signals. The sensor device 3 can comprise corresponding movement detectors, which deliver a signal for the occupant movement and a signal for the airbag advance movement (FIG. 2). The electrical sensor signals are supplied to a control unit 4 that is an electronic calculator. In dependence on the sensor signals, the quantity of inflation gas supplied to the airbag by the inflator 2 is controlled. Adjustment devices known for instance from DE 100 45 035 A1 and EP 0 974 500 A1 can be controlled by the control device 4 for the controlling the cross section of a passage for the inflation gas supplied to the airbag. In addition, the inflation gas amount generated by the inflator 2 can be controlled.

The electrical sensor signals that detect the movement of the vehicle occupant, as well as the sensor signals that detect the movement of the airbag toward the vehicle occupant are evaluated for control purposes.

A sensor device 3, which is a radar sensor device, working along the Doppler radar principle detects vehicle occupant movement as of detecting movement of the airbag toward the vehicle occupant. Such sensor devices are known for instance from German patent DE 195 35 962 C1 and EP 0 638 818 B1. A suitable sensor device, with which a location selective speed measurement is described according to the Doppler principle, is taught by DE 44 20 432 A1. The sensor device comprises a high frequency transmitter, in particular for the GHz range. High frequency signals are emitted via an antenna and reflected from the body of the vehicle occupant 5 and suitable reflectors or transponders 13 which in the present invention may be located on the airbag fabric, and received as echo or answering signals by the sensor device 3. Suitable transponders are for instance described in DE 100 24 474 A1 and EP 0 618 460 B1.

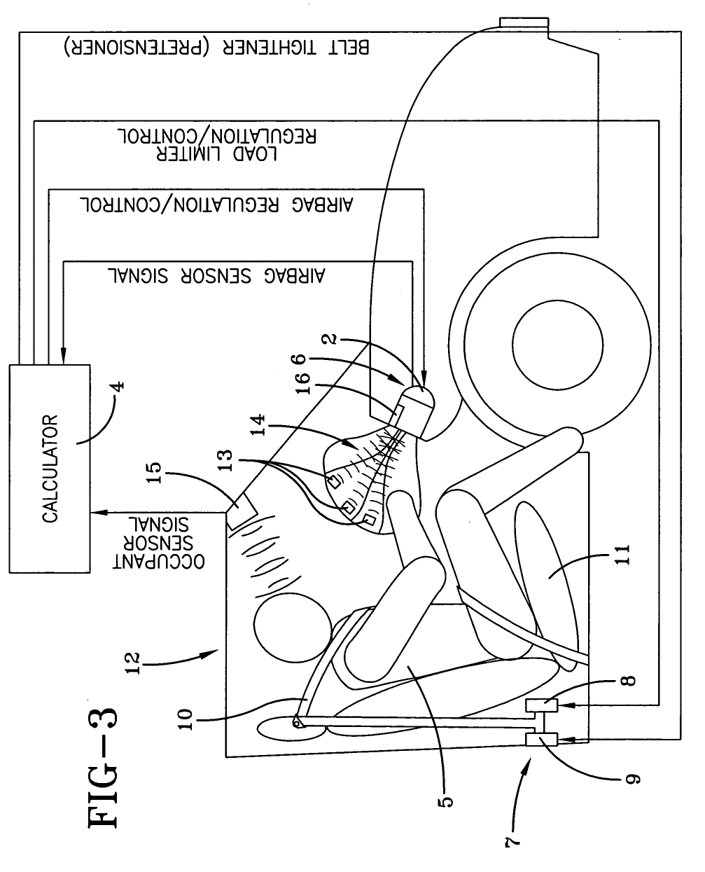

In the embodiment of FIGS. 1 and 2, the sensor device, which also measures vehicle occupant movement, is a component with the airbag module 6. In the embodiment of FIG. 3, a separate sensor device 15, for instance a movement detector, is provided for detecting occupant movement. A sensor device 16, which measures the advance movement (speed and/or acceleration) of the airbag 1, is located in the proximity of the airbag module 6 or within the airbag module 6. In the embodiment of FIG. 3, the separate sensor device 15 is located in the transversely running upper roof beam region, which borders the front pane of the vehicle 12. This separate sensor unit can also be arranged in another suitable position, in which the occupant movement, in particular the head and/or thorax movement can be detected. The sensor device 15 can be an infrared movement detector or an optical movement detector with movement image detection, or as a radar, in particular a Doppler radar movement detector.

The sensor that is integrated in the sensor device 3 and measures the movement of the airbag toward a vehicle occupant in the embodiment of FIGS. 1 and 2, as well as the sensor device 16 of the embodiment of FIG. 3 can, in addition to the reflectors and/or transponders 13, comprise detection bands or detection cords 14 connected to the airbag fabric, with which the movement of the airbag toward a vehicle occupant 1 can be detected. The evaluation of the detection signals caused by the detection bands or detection cords 14 can take place in the manner known from EP 0 812 741 B1.

The echo or answering signals reflected by the reflectors and/or transponders 13 are evaluated in the control device 4 by the sensor device 3, 16 for the movement of the airbag toward a vehicle occupant 1, separately from the detection signals generated by the detection bands or detection cords 14. A comparison can be made in the control device 4 of the detection signals gained in parallel for the advance movement. In this way, a redundant detection of the movement of the airbag toward a vehicle occupant 1 is achieved.

The detection of the movement of the vehicle occupant preferably takes place prior to the initiation of airbag inflation, as shown in FIG. 1. On the basis of the movement pattern of the vehicle occupant already detected prior to initiation of airbag inflation by corresponding sensor signals, and on the basis of a corresponding evaluation, a pre-adjustment of the devices with which the gas supply to the airbag 1 is controlled, can be achieved by the control device 4. In FIG. 2, detection of the advance movement of the airbag is achieved during the inflation process and during the advance movement of the airbag 1. At the same time, the movement of the vehicle occupant can further be detected by the sensor device of the embodiment of FIGS. 1 and 2 or by the sensor device 15 of the embodiment of FIG. 3.

If the advance movement 1 of the airbag is slow and the vehicle occupant 5 moves forward, i.e. toward the airbag, at high speed, in particular in the head and/or thorax region, on the basis of the generated sensor signals the control device 4 can instruct the inflator 2 and/or the adjustment means that work with the inflator to inflate the airbag more rapidly. The flow cross section of the inflation gas conduit can for instance be adjusted in this manner.

The reflectors or transponders 13 are located at particular points on the airbag fabric, so that the expansion of the airbag fabric into the vehicle can be detected in a location specific manner. As mentioned previously, additional information about the advance movement of the airbag can be gained from the detection cords or detection bands 14 connected to the airbag fabric at various points.

In a crash, an adjustment of the load limitation can be carried out by the sensor signals which reflect the movement pattern of the vehicle occupant 5, to achieve a set restraining force of a seat belt 10 worn by the vehicle occupant 5. The belt retractor comprises a control access 8 for the corresponding control signals of the control device 4. Corresponding force limitation degrees can be adjusted in a belt retractor 7 for the seat belt 10. Variably adjustable force limitation degrees are known for instance from EP 0 856 443 B1.

Detection of the movement of the vehicle occupant 5 takes place at least in a timeframe that lies between the beginning of the crash and the resulting airbag inflation. The beginning of the crash can be detected by sensitive determination of the exceeding of a vehicle deceleration or acceleration threshold. From this moment in time to the initiation of the airbag inflation process, approximately 15 milliseconds can pass. The detection of vehicle occupant movement, in particular in the head and/or thorax region, takes place within this timeframe, preferably by Doppler radar.

The detection of vehicle occupant movement, however, can also take place in a driving situation in which a high likelihood for a crash exists, for instance if the vehicle undergoes emergency braking or skidding, and in similarly critical driving situations. This type of driving situation is detected by corresponding sensor technology. The detection of vehicle occupant movement by the sensor device 3 (FIG. 1 and 2) or the sensor device 15 (FIG. 3) is then activated. In dependence thereon, the calculator 4 can then evaluate the corresponding sensor signals to the effect that a belt pretensioning can be correspondingly controlled, for instance with the help of an electric motor drive acting upon the belt reel of the belt retractor 7. In this case the vehicle occupant 5 can for instance be moved from an Out-Of-Position location to a normal seating position. This type of electric motor drive is for instance known from DE 43 32 205 C2. The belt retractor 7 can comprise a corresponding control access 8 or 9 for the belt retractor activation.

While the foregoing examples illustrate and describe the use of the present invention, they are not intended to limit the invention as disclosed in certain preferred embodiments herein. Therefore, variations and modifications commensurate with the above teachings and the skill and/or knowledge of the relevant art, are within the scope of the present invention.

1. An apparatus for controlling the inflation of an airbag in a vehicle comprising:
(a) an inflator for providing inflation gas to an airbag,
(b) a sensor device for detecting the position of a vehicle occupant to be restrained by the airbag; and
(c) a control device which, in dependence on the detected position of the vehicle occupant, controls a supply of the inflation gas to the airbag, wherein the sensor device measures movement of the vehicle occupant and movement of the airbag toward a vehicle occupant, and the control device controls the supply of inflation gas to the airbag in dependence on two sensor signals.

2. The apparatus of claim 1, wherein the sensor device comprises a first movement detector that measures the movement of the vehicle occupant, and a second movement detector that measures the movement of the airbag toward a vehicle occupant.

3. The apparatus of claim 1, wherein the two movement detectors for the detection of the vehicle occupant movement and the airbag advance movement form the units of one component.

4. The apparatus of claim 2, wherein the two movement detectors for the detection of the vehicle occupant movement and the airbag advance movement form the units of one component.

5. The apparatus of claim 1, wherein the two movement detectors are separately arranged sensor devices within the vehicle.

6. The apparatus of claim 2, wherein the two movement detectors are separately arranged sensor devices within the vehicle.

7. The apparatus of claim 1, wherein an airbag module comprising the airbag and the inflator is a component with the sensor device.

8. The apparatus of claim 2, wherein an airbag module comprising the airbag and the inflator is a component with the sensor device.

9. The apparatus of claim 3, wherein an airbag module comprising the airbag and the inflator is a component with the sensor device.

10. The apparatus of claim 4, wherein an airbag module comprising the airbag and the inflator is a component with the sensor device.

11. The apparatus of claim 2, wherein at least one of the movement detectors is a radar sensor.

12. The apparatus of claim 3, wherein at least one of the movement detectors is a radar sensor.

13. The apparatus of claim 4, wherein at least one of the movement detectors is a radar sensor.

14. The apparatus of claim 2, wherein the movement detector for the advance movement of the airbag comprises a control device that analyzes two parallel switched movement detectors, which detect the advance movement of the airbag.

15. The apparatus of claim 3, wherein the movement detector for the advance movement of the airbag comprises a control device that analyzes two parallel switched movement detectors, which detect the advance movement of the airbag.

16. The apparatus of claim 4, wherein the movement detector for the advance movement of the airbag comprises a control device that analyzes two parallel switched movement detectors, which detect the advance movement of the airbag.

17. The apparatus of claim 2, wherein the first movement detector that measures the movement of the vehicle occupant is located in front of the occupant seat in the vehicle.

18. The apparatus of claim 17, wherein the first movement detector that measures the movement of the vehicle occupant is an infrared sensor.

19. The apparatus of claim 17, wherein the first movement detector that measures the movement of the vehicle occupant is an optical sensor.

20. The apparatus of claim 17, wherein the first movement detector that measures the movement of the vehicle occupant is a radar sensor.
